(19) United States
(12) Patent Application Publication
(10) Pub. No.: US 2006/0231536 A1
(43) Pub. Date: Oct. 19, 2006

(54) Method for the introduction of an integrated predetermined rupture line in a planar expansive body

(76) Inventors: Martin Griebel, Jena (DE); Frank Steinhaeuser, Magdala (DE); Norbert Preuss, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/535,601

(22) PCT Filed: Oct. 29, 2003
(86) PCT No.: PCT/DE03/03637

§ 371 Date: Mar. 31, 2006

(30) Foreign Application Priority Data
Nov. 19, 2002 (DE) 10254377.1

(51) Int. Cl. B23K 26/38

(52) U.S. Cl. 219/121.71; 219/121.72

(57) ABSTRACT

The invention is directed to a method for introducing an integrated predetermined breaking line in a planar extending article. The method is particularly suitable for introducing an invisible predetermined breaking line with a reproducible, defined tearing resistance by means of a laser in an inhomogeneous material, such as a woven material, which can serve as the decorative layer of an airbag covering. According to the invention, the laser output is controlled depending upon the amount of material along the desired predetermined breaking line.

### CROSS-REFERENCE TO RELATED APPLICATION

This application claims priority of International Application No. PCT/DE2003/003637, filed October 29, and German Application No. 102 54 377.1, filed Nov. 19, 2002, the complete disclosures of which are hereby incorporated by reference.

### BACKGROUND OF THE INVENTION

a) Field of the Invention

The invention is directed to a method for introducing an integrated predetermined breaking line in a planar extending article. The method is particularly suitable for introducing an invisible predetermined breaking line with a reproducible, defined tearing resistance by means of a laser in an inhomogeneous material such as a woven material. A method of this generic type is described in DE 196 36 429 C1.

b) Description of the Related Art

At the present time, it is common in many fields of application to introduce integrated predetermined breaking lines in planar extending articles in order to open these articles along this predetermined breaking line in case of need. Examples include facilitated tearing and severing in packaging and office products, predetermined breaking points in device housings, e.g., for use of the housing with various device constructions, or predetermined breaking lines in airbag coverings that allow the airbag to pass through without hindrance when activated.

Production of predetermined breaking lines in airbag coverings represents a special case because of the high safety risk involved. Since the method according to the invention is particularly suitable for producing a predetermined breaking line with the special requirements existing for an airbag covering, it will be described with reference to airbag coverings, but is not limited to this. Also, the state of the art is such that methods for introducing a predetermined breaking line with defined, reproducible tearing force such as is provided by the method according to the invention are described almost exclusively with reference to airbag coverings.

Many methods are known which make it possible to introduce a predetermined breaking line in an airbag covering. Initially, only the dashboard panel or steering wheel hub were considered as coverings for a front airbag. In the meantime, it has become standard to conceal a side airbag in door paneling and seat cushions, or a head airbag in the inside roof lining of vehicles, or even a front airbag in the seat belt, e.g., for passengers in the rear seats.

This has led to an increase not only in the multiplicity of designs of airbag coverings but also in the variety of materials which are used for this purpose and from which the airbag covering is produced in one or more layers. Conventional airbag coverings in the dashboard generally include a rigid carrier layer, a soft foamed material layer, and a decorative layer facing the seating compartment of the vehicle. However, it can also comprise only a fixed carrier layer that is covered by a decorative layer or only a carrier layer with a decorative surface. Plastic sheeting is used in particular as a decorative layer. It has a substantially homogeneous material density distribution over the layer thickness and along the desired predetermined breaking line. Laser cutting is known as the preferred method for introducing a predetermined breaking line of this type into airbag coverings comprising the materials described above. No methods employing a laser are known from the prior art for introducing a predetermined breaking line in airbag coverings with a textile or other decorative layer having an inhomogeneous material density distribution.

The prior art covers all those methods in which a predetermined breaking line is either introduced into a planar extending article by laser or the planar extending article in which a predetermined breaking line is to be introduced comprises a material with an inhomogeneous material density distribution such as a woven material.

Even when not expressly mentioned in all of the references to be evaluated in the following, a predetermined breaking line which has a defined tearing force and which is invisible from the seating compartment of the vehicle (decorative side of the airbag covering) for aesthetic reasons must be generated in every case. All of the prior art laser methods that are described in this respect have in common that a laser beam is directed to the back of a prefabricated layer (e.g., carrier layer or decorative layer) or of the entire airbag covering comprising one or more layers and the laser beam is moved relative to this back side so that the laser beam describes a line along the desired predetermined breaking line on the back side. The parameters such as the type and wavelength of laser radiation, laser output, relative speed, pulse duration and pulse frequency, as well as possible regulation of these parameters, vary in the methods known from the art.

U.S. Pat. No. 5,883,356 describes a method in which the thickness of a workpiece, particularly a dashboard whose material construction is not described more fully, is measured along a predetermined breaking line to be introduced. These thickness measurements are stored in such a way that they are associated with spatial data and serve subsequently for spatially dependent control of the laser in order to achieve a constant and, therefore, defined residual wall thickness over the predetermined breaking line. The homogeneity of the material along the predetermined breaking line, which is generally given for plastics, is a precondition for actually achieving a constant residual wall thickness along the predetermined breaking line when controlling the laser parameters as a function of the material thickness.

EP 711 627 B 1 discloses a method for generating a predetermined breaking line in a single-layer planar article with a working side and a decorative side which, according to the description, can also be a woven textile and, therefore, an inhomogeneous material. The basic idea behind the technical solution described herein is that the ablation depth or residual wall thickness of the material is detected by a sensor and the sensor signal is used as a control signal for the laser in order to produce a predetermined breaking line of defined residual wall thickness. However, generating a line of determinate residual wall thickness in textile material is completely impossible because of the inhomogeneous material density distribution. On the other hand, a line with a maximum residual wall thickness could be generated, but this could not be sensed using the sensor principles provided in this publication.

DE 196 36 429 C1 (Priority Application for U.S. Pat. No. 5,882,572) discloses a method in which a series of blind holes with a determined residual wall thickness is generated in a flat material by means of controllably pulsed laser radiation. For this purpose, the laser beam is directed to the surface of the flat material until the residual wall thickness at the point of impingement is reduced by laser removal of material to the extent that the radiation transmitted through the residual wall is detected by a detector and the laser is abruptly switched off when a given threshold of the detector is exceeded. The sensitivity of the detector is adjusted according to the given threshold. If the full laser radiation were to strike the detector, the detector would be overloaded and would be out of operation at least for the following detection.

DE 101 28 745 A1 proposes, among other things, to apply the method described in DE 196 36 429 C1 in combination with the generation of perforations with an elongated slit geometry in paneling parts. Instrument panels, seat coverings, seat linings, pillar paneling and interior roof linings are mentioned as examples of paneling parts.

However, the Applicant of the present invention and owner of the patent DE 196 36 429 C1 has recognized that this method is not suitable for generating a series of blind holes for working inhomogeneous materials such as a woven material in which even a first laser pulse passing through between the thread structure could strike the detector at full output.

In U.S. Pat. No. 5,632,914, a predetermined breaking line is introduced into a decorative layer which is referred to herein expressly as an elastic plastic skin. This is carried out by means of a laser by producing a series of microperforations which are not visible to the human eye. However, it is not expressly mentioned, even though this is compulsory for generating microperforations, that the laser beam must be turned off immediately when the material is penetrated so as to maintain a minimum diameter. In many materials, however, the material penetration is visible not because the hole diameter is perceptible, but rather because of surface warping or discoloration due to melted material.

The solutions mentioned above, as well as other solutions of this kind, have the common goal of introducing a predetermined breaking line with a reproducible tearing resistance defined along its length. The tearing resistance should be low on the one hand so that the predetermined breaking line can be destroyed by only a slight tearing force in case of activation of the airbag, but on the other hand the predetermined breaking line should not rupture merely as the result of an uncontrolled random application of force in the seating compartment.

In order to achieve a defined tearing resistance over the length of the predetermined breaking line, the material is weakened in principle either uniformly when it has a constant thickness (removal of material to a defined depth) or, when the thickness varies, is removed until a defined residual wall thickness is achieved. Removal of material to a defined depth in case of constant thickness and removal until reaching a defined residual wall thickness can only be correlated to a definite tearing resistance when the material is homogeneous, i.e., there is an identical amount of material through which the radiation is transmitted along an identical residual wall thickness.

None of the methods mentioned above is suitable for working a decorative layer of inhomogeneous material such as woven material or an airbag covering with a decorative layer of this kind. A woven material is formed in principle by a plurality of threads (longitudinal threads) extending in one direction (longitudinal direction) and a plurality of threads (cross threads) extending in a direction perpendicular thereto (transverse direction) that are woven together. Nonwoven planar extending articles which nevertheless have a woven structure of this type are also considered woven within the meaning of the present invention. When the woven material is cut crosswise next to a cross thread, a sectional view will show two rows of thread cross sections arranged one above the other so as to be offset by one half relative to one another. It is immediately clear from this view that a defined depth cut with determined positions of the predetermined breaking line relative to the woven structure can result in that either only the threads of the bottom row, and therefore every second thread, are weakened or in that these threads are completely severed, which will quickly result in an unraveling of the woven material along this line.

In order to introduce a predetermined breaking line in a woven material, solutions are known in particular in which a weaker thread is woven into the woven material along the desired predetermined breaking line or the woven material is cut and sewn back together with a weaker thread.

A woven predetermined breaking line of the type mentioned above is shown, e.g., in DE 199 47 585 for a belt strap in which an airbag is accommodated. In EP 1 010 591, an airbag enclosure is sewn together along its predetermined breaking line; in this case, the selected stitch and the strength of the thread are crucial for the tearing resistance. In U.S. Pat. No. 5,676,394, the description of the prior art shows a solution in which the airbag passes through a seam that already exists in the cover material of the back of a seat. The tearing of a seam of this kind is criticized as unreliable. It is suggested, as an alternative, to introduce into the seat a rubber or plastic airbag covering that is sewn together with the covering material and provided with an invisible line-shaped weakening. This means that when the airbag is activated, the line-shaped weakening in the rubber or plastic article is destroyed rather than the seam. That is, the predetermined breaking line in the covering material is replaced by a predetermined breaking line in a homogeneous material such as rubber or plastic, which indicates that a predetermined breaking line in the covering material, produced according to the prior art, is not given the required quality.

Further, weaving in weaker threads along the predetermined breaking line has the disadvantage that the woven material cannot be cut to size with a view to minimum waste, but must instead be oriented exactly to the weaker threads so that the predetermined breaking line lies at the correct location within the cut out woven material.

Also, creating a predetermined breaking line by cutting and then resewing is less economical. It is practically impossible to introduce a predetermined breaking line in a woven material after the finished layer construction comprising carrier/foamed material/woven material or carrier/woven or foamed material/woven material has been produced.

### OBJECT AND SUMMARY OF THE INVENTION

It is the primary object of the invention to provide a method using a laser by which a predetermined breaking line with reproducible and defined tearing force can be introduced in a planar extending article in which at least one layer comprises an inhomogeneous material.

The object of the invention is met, in accordance with the invention, by a method for generating a predetermined breaking line in a one-layer planar extending article, having a working side and a decorative side comprising a material with an inhomogeneous material density distribution. He method comprises the steps of directing a laser beam bundle to the working side for removing material in its beam path and thereby generating holes that are invisible from the decorative side. The laser beam bundle and the planar extending article carrying out a relative movement with respect to one another so that the holes are generated in a row along the desired predetermined breaking line. The laser beam is switched off for a period of time determining the subsequent hole spacing when an amount of radiation generating a detector signal that is greater than a predetermined threshold signal impinges on a detector arranged on the decorative side. The output of the laser beam is gradually increased from zero to its maximum nominal value before starting to produce each hole. The laser beam is switched off immediately when a detector signal that is greater than the predetermined threshold is generated before reaching the maximum nominal value, which is caused by the absence of material or by a small amount of material of the planar extending article in the beam path (pseudo-hole) and prevents removal of the small amount of material and prevents overloading of the detector.

In principle, the method according to the invention is suitable for introducing a predetermined breaking line in any materials in which a predetermined breaking line can be introduced by means of a laser in accordance with the cited prior art methods. However, the special advantages of the method are revealed only in connection with a textile surface or other inhomogeneous material. By textile surface is meant materials in which natural and/or synthetic fibers arranged with respect to one another in an ordered (woven, knitted) or random (felted or matted) manner form a layer. Generally, there is air between the fibers. Examples of textile surfaces are materials that are woven or knitted from natural or synthetic fibers or threads as well as formed fabric or felt. By inhomogeneous materials is also meant, e.g., foamed materials and porous ceramics.

The invention will be described more fully in the following with reference to embodiment examples.

### BRIEF DESCRIPTION OF THE DRAWINGS

FIG. 1 shows a section through a woven material 1 with a laser beam bundle 4 directed perpendicular thereto; and

FIG. 2 shows a section through a woven material 1 with a laser beam bundle 4 directed diagonal thereto.

### DESCRIPTION OF THE PREFERRED EMBODIMENTS

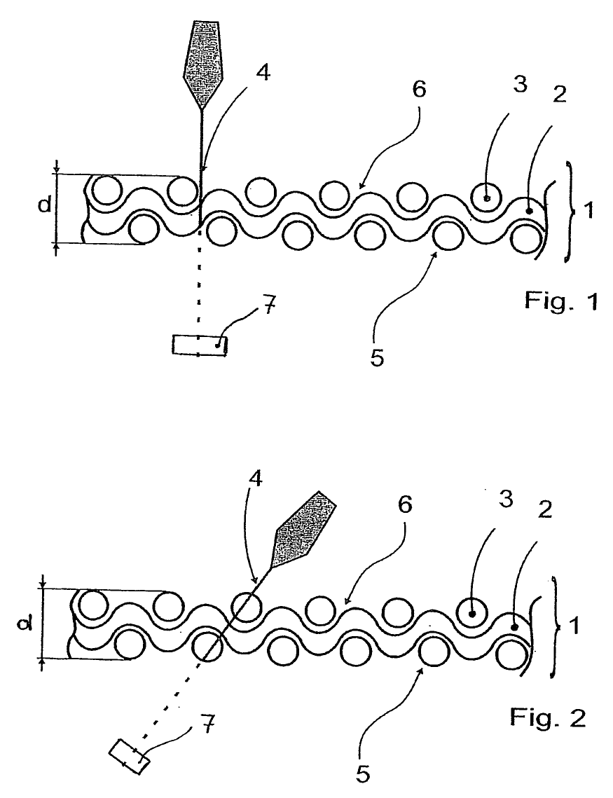

A first embodiment example shows the laser cutting of a woven material 1 comprising natural fibers. The material in question can be a covering material for a seat or the decorative layer for door paneling. FIG. 1 shows a section through a woven material 1 of this kind along a cross thread 2. A plurality of fibers bundled together forms a thread. A plurality of longitudinal threads 3 arranged next to one another are woven together with a plurality of cross threads 2 lying next to one another. The view in which the distances between the threads have been exaggerated clearly shows that a laser beam bundle 4, shown here as an individual beam, impinging on the woven material can penetrate the woven material 1 without striking a thread. At the other extreme, the laser beam bundle 4 could penetrate through the center of two threads lying on top of one another in another location. This means that although the woven material 1 has a substantially constant thickness d, the amount of material needing to be removed can vary between zero and a maximum value. It is clear that the removal of material, particularly when this removal should not be visible from one side of the woven material 1 (decorative side 5), must take place in a regulated manner so that the cutting laser beam acts on the material for exactly as long as is required to produce a blind hole of the desired residual wall thickness. However, in contrast to the usual meaning in the prior art, the residual wall thickness may not refer to a remainder of material remaining directly at the decorative side 5 of the material layer; rather, this material remainder can exist at any depth within the thickness d of the woven material 1. Also, within the meaning of the invention, the desired residual wall thickness need not necessarily refer to a determinate wall thickness, but rather to a determinate amount of material transmitting an amount of radiation that generates a threshold signal when impinging on a detector. Accordingly, the residual wall thickness may vary depending, e.g., on how closely the fibers forming a thread lie on top of one another.

As is known in the prior art from DE 196 36 429 C1, the removal of material and therefore the remaining residual wall thickness for a blind hole can be carried out in a regulated manner in principle in that the radiation of the cutting laser transmitted through the material remainder (residual wall) is detected by means of a sensor. The impinging amount of radiation generates a sensor signal. As soon as this sensor signal exceeds a given threshold value, the laser beam is turned off. The time period between the generation of the threshold signal and the switching off of the laser beam will be referred to hereinafter as the response time. This known method assumes that the material layer has a wall thickness greater than or equal to the desired residual wall thickness all along the desired predetermined breaking line. However, as was mentioned earlier, this is not the case for a woven material 1.

The underlying idea of the invention is to improve a method of this kind through additional method steps in such a way that it can also be successfully applied when the wall thickness along the desired predetermined breaking line can fall short of the desired residual wall thickness in places down to zero.

Like the method known from the prior art for introducing a predetermined breaking line, the planar extending article, in this case a woven material 1, in which a predetermined breaking line is to be introduced by means of a laser is moved into the beam path of a cutting laser in a first method step in such a way that a laser beam bundle 4 emitted by the cutting laser impinges perpendicularly on the working side 6 of the woven material 1 opposite from the decorative side 5. A detector 7 is arranged on the decorative side 5 in such a way that a beam component of the laser beam bundle 4 transmitted through the material layer strikes the detector 7. The material layer is now positioned in the beam path in such a way that a point on the surface around which a first blind hole is to be generated lies in the beam path. In contrast to all of the known methods of this type, the laser output is now gradually increased from zero to a maximum of 100% of its nominal value. By “gradually” is meant, within the meaning of the invention, that the time period expiring before reaching the 100% nominal value is greater than the response time of the sensor. When transmitted beam components generating a signal greater than a predetermined threshold value correlated to a desired residual wall thickness are already received by the detector 7 while increasing laser output, the laser is immediately switched off. This occurs when the material thickness of the material layer at this location is less than the desired residual wall thickness. In this case, no material is removed because the material is already sufficiently weak in this area. A location of this kind where no material has been detected, or where an amount of material with a thickness less than that of the desired residual wall thickness has been detected, is referred to hereinafter as a pseudo-hole.

Regardless of whether the cutting laser beam is turned on or turned off, the woven material 1 is moved at a constant speed in the range of 10 to 80 mm/s in such a way that it is guided along the desired predetermined breaking line through the beam path. It will be appreciated by the person skilled in the art that in order to generate the required relative movement the cutting laser can also be moved relative to the woven material 1 or the relative movement could be stopped during lasing, i.e., during the generation of a blind hole.

As soon as the next point around which a blind hole is to be generated lies in the beam path—this results after a set period of time, given a constant speed and constant hole spacing—the laser output is increased again. Assuming, for example, that there is a greater amount of material at this location which does not allow, or does not allow to a sufficient extent, a transmission of beam components the removal of material commences until, in a known manner, the residual wall thickness is small enough that the beam components that are then transmitted cause a signal at the detector 7 which is above the given threshold and the laser is switched off.

The relatively slow increase in radiation output prevents overloading of the detector 7 on the one hand and, on the other hand, prevents a material puncture at locations that are thinner than the desired residual wall thickness. The laser can be operated in pulsed or continuous laser output mode. The reference output of the laser depends substantially on the material characteristics of the woven material 1. A 10-Watt CO₂ laser is very well suited. As usual in methods of this type, it is advantageous to eliminate burnt residue by means of suitable venting and suction.

The choice of hole spacing depends substantially upon the tearing strength of the fibrous material, the number of fibers per thread, the weave density and the desired tearing resistance of the predetermined breaking line. The optimal hole spacing is determined most expediently by experimentation. It may be constant along the length of the predetermined breaking line, or may take on different periodically recurring values, or may vary portion by portion or change continuously, e.g., in order to increase the tearing resistance toward a hinge formed at the end of the predetermined breaking line. In principle, the selected hole spacing could also be smaller after detection of a pseudo-hole in order to increase the likelihood that a thread will in fact be struck in the subsequent work step.

In order to dependably weaken every thread along the desired predetermined breaking line, the hole spacing should not be greater than the thread diameter. A virtually uniform weakening of the threads in question is achieved when the hole spacing is selected so as to equal half of the thread diameter. Even when the thread spacing varies along the desired predetermined breaking line, the threads in question will be perforated either once in the middle or twice off center.

In a second embodiment example, a woven material 1 with a structure such as that shown in FIG. 1 is worked. In this case, however, the individual threads are synthetic fibers with a particularly high tearing strength. As was described with the variant of the method according to the invention that was described in the first embodiment example, the material weakening is not sufficient in this case to adjust the desired tearing resistance. In order to remove a greater amount of material along the predetermined breaking line, the laser beam is not directed to the surface of the woven material 1 perpendicularly in this case, but rather at an incident angle of less than 90°, preferably between 70° and 30° to the surface of the woven material 1 so that the path through the woven material 1 is increased. Further, this reduces the probability that an insufficient amount of material for which no material removal is carried out will be present in the beam path. The detector 7 must then be arranged so as to be offset in a corresponding manner so that it can detect the transmitted beam components.

In a third embodiment example, the method is to be applied to a textile surface with back-foaming. In this case, the foamed material layer is initially severed almost completely along the length of the predetermined breaking line (preparatory cut) in one method step by means of the laser beam and then, in another method step analogous to the embodiment examples described above, the textile surface is worked. During the preparatory cut, the detector 7 is switched off or switched to a lower sensitivity range (desensitized) in order to prevent overloading. The textile back-foamed surface can advantageously be stretched on a slightly convex surface. This causes the foamed material layer to gape open along the cut line and makes it easier to prevent further burning or melting of the foamed material while generating blind holes in the textile surface.

The method can likewise be applied to an airbag covering that has already been mounted and that comprises a fixed carrier layer, a foamed material layer, and a textile surface as decorative layer. As in the embodiment example described above, the method can be carried out in two steps in which a preparatory cut is generated first and then perforation is carried out proceeding from the preparatory cut, or blind holes are produced through all layers as will be described with reference to a fourth embodiment example showing another variant of the method according to the invention. The laser beam is directed to the working side 6 of the airbag covering and now initially strikes the carrier layer. In order to work on the carrier layer, a laser is required which has an appreciably higher output than in the first embodiment example. A 1500-Watt CO2 laser is optimal. Starting with full power or almost full power, a through-hole is first generated in the carrier layer and the output is decreased appreciably to less than 30% shortly before or directly at the transition of the carrier layer to the foamed material layer. Toward the end of the foamed material layer, the beam output is reduced to zero, so that the threshold signal is not generated by a beam transmitting through a remainder of the foamed material, and is then increased again after completely penetrating the foamed material layer as was described in detail with reference to the first embodiment example.

In principle, the method according to the invention can also be advantageously applied to weaken a material layer through a series of microperforations. The threshold at which the laser is switched off is then selected in such a way that even a very small beam component penetrating through the opening causes the laser to shut off. This method variant is suitable in particular for textile surfaces with an “open” structure on the decorative side 5, e.g., formed by flocking, roughening and looping (pile, velour, Malimo, terrycloth). The structures determining the tearing resistance are completely penetrated and the openings occurring on the decorative side 5 are not visible because of the open structure.

It is advantageous when the cutting laser beam bundle is focused by beam-shaping optics with a large image-side aperture on the surface of the decorative side 5. The weakening is accordingly carried out on the working side 6 by a larger beam cross section which decreases toward the decorative side 5. The cutting laser beam can also be directed to the planar extending article to be cut by placing the latter deliberately outside the focal range in order to weaken the material over a relatively large beam cross section.

It can also be advantageous when a measurement beam is coupled into the beam path of the cutting laser and this measurement beam, rather than the cutting laser beam, is detected by the detector 7. A solution of this kind could be useful when the inhomogeneous material is not transparent for the cutting laser radiation.

While the foregoing description and drawings represent the present invention, it will be obvious to those skilled in the art that various changes may be made therein without departing from the true spirit and scope of the present invention.

1-10. (canceled)

11. A method for generating a predetermined breaking line in a one-layer planar extending article having a working side and a decorative side, comprising a material with an inhomogeneous material density distribution, said method comprising the steps of:
directing a laser beam bundle to the working side for removing material in its beam path and thereby generating holes that are invisible from the decorative side;
the laser beam bundle and the planar extending article carrying out a relative movement with respect to one another so that the holes are generated in a row along the desired predetermined breaking line;
switching off the laser beam for a period of time determining the subsequent hole spacing when an amount of radiation generating a detector signal that is greater than a predetermined threshold signal impinges on a detector arranged on the decorative side;
gradually increasing the output of the laser beam from zero to its maximum nominal value before starting to produce each hole; and
switching off the laser beam immediately when a detector signal that is greater than the predetermined threshold is generated before reaching the maximum nominal value, which is caused by the absence of material or by a small amount of material of the planar extending article in the beam path (pseudo-hole) and prevents removal of the small amount of material and prevents overloading of the detector.

12. The method for generating a predetermined breaking line in a multiple-layer planar extending article with a working side and a decorative side, in which the layer (final layer) forming the decorative side, said method comprising an inhomogeneous material, comprising the steps of:
directing a laser beam bundle to the working side for removing material in its beam path and thereby generating holes that are invisible from the decorative side;
the laser beam bundle and the planar extending article carrying out a relative movement with respect to one another so that the holes are generated in a row along the desired predetermined breaking line;
switching off the laser beam for a period of time determining the subsequent hole spacing when an amount of radiation generating a detector signal that is greater than a predetermined threshold signal impinges upon a detector arranged on the decorative side;
reducing the output of the laser beam prior to penetration of the laser beam into the final layer at least until the amount of radiation still being emitted generates a signal smaller than the threshold with full detection;
activating the detector and subsequently increasing the laser beam again gradually to its maximum nominal value; and
switching off the laser beam immediately when a detector signal that is greater than the predetermined threshold is generated before reaching the maximum nominal value, which is caused by the absence of material or by a small amount of material of the planar extending article in the beam path (pseudo-hole) and prevents removal of the small amount of material and prevents overloading of the detector.

13. The method according to claim 12, wherein a preparatory cut is introduced along the desired predetermined breaking line from the working side to, at most, the final layer before generating the row of holes, wherein the detector is desensitized or deactivated in order to protect it from possible overload.

14. The method according to claim 11, wherein the threshold signal is selected in such a way that it is generated already by an amount of radiation that transmits through a residual wall of material of the planar extending article so that the holes are formed as blind holes.

15. The method according to claim 12, wherein the threshold signal is selected in such a way that it is generated already by an amount of radiation that transmits through a residual wall of material of the planar extending article so that the holes are formed as blind holes.

16. The method according to claim 11, wherein when working an inhomogeneous material that is a textile surface having an open structure on the decorative side, the threshold signal is selected in such a way that an amount of radiation that generates a signal greater than the threshold signal is not detected until after the direct penetration of the decorative side so that the holes are formed as microperforations.

17. The method according to claim 12, wherein when working an inhomogeneous material that is a textile surface having an open structure on the decorative side, the threshold signal is selected in such a way that an amount of radiation that generates a signal greater than the threshold signal is not detected until after the direct penetration of the decorative side so that the holes are formed as microperforations.

18. The method according to claim 14, wherein the laser beam impinges on the working side at an angle of less than 90° relative to the direction of the predetermined breaking line in order to increase the length of the beam path in the planar extending article, which leads to removal of a greater amount of material with hole spacing remaining constant or allows greater hole spacing.

19. The method according to claim 15, wherein the laser beam impinges on the working side at an angle of less than 90° relative to the direction of the predetermined breaking line in order to increase the length of the beam path in the planar extending article, which leads to removal of a greater amount of material with hole spacing remaining constant or allows greater hole spacing.

20. The method according to claim 16, wherein the laser beam impinges on the working side at an angle of less than 90° relative to the direction of the predetermined breaking line in order to increase the length of the beam path in the planar extending article, which leads to removal of a greater amount of material with hole spacing remaining constant or allows greater hole spacing.

21. The method according to claim 17, wherein the laser beam impinges on the working side at an angle of less than 90° relative to the direction of the predetermined breaking line in order to increase the length of the beam path in the planar extending article, which leads to removal of a greater amount of material with hole spacing remaining constant or allows greater hole spacing.

22. The method according to claim 11, wherein the selected hole spacing between a pseudo-hole and a subsequent blind hole or microperforation is less than the other hole spacings.

23. The method according to claim 12, wherein the selected hole spacing between a pseudo-hole and a subsequent blind hole or microperforation is less than the other hole spacings.

24. The method according to claim 11, wherein the laser beam bundle is shaped in such a way on the working side that its cross section decreases toward the decorative side.

25. The method according to claim 12, wherein the laser beam bundle is shaped in such a way on the working side that its cross section decreases toward the decorative side.

26. The method according to claim 11, wherein when working an inhomogeneous material that is a woven material comprising longitudinal threads and cross threads, the selected hole spacing is less than the thread diameter.

27. The method according to claim 12, wherein when working an inhomogeneous material that is a woven material comprising longitudinal threads and cross threads, the selected hole spacing is less than the thread diameter.

28. The method according to claim 26, wherein the selected hole spacing is equal to half of the thread diameter so that each thread is weakened by two holes insofar as the hole is not generated over the thread diameter.

29. The method according to claim 12, wherein the selected hole spacing is equal to half of the thread diameter so that each thread is weakened by two holes insofar as the hole is not generated over the thread diameter.
